(19) United States
(12) Patent Application Publication
(10) Pub. No.: US 2012/0251926 A1
(43) Pub. Date: Oct. 4, 2012

(54) Thin Film Catalyst With Heat-Extendable Wires

(75) Inventor: Alireza Pezhman Shirvanian, Ann Arbor, MI (US)

(73) Assignee: Ford Global Technologies, LLC, Dearborn, MI (US)

(21) Appl. No.: 13/523,205

(22) Filed: Jun. 14, 2012

Related U.S. Application Data
(63) Continuation-in-part of application No. 12/770,277, filed on Apr. 29, 2010.
Application No. 12/770,277 is a continuation-in-part of application No. 12/770,084, filed on Apr. 29, 2010.

(51) Int. Cl. H01M 4/86; H01M 4/88; B82Y 30/00

(52) U.S. Cl. 429/530; 427/115; 977/758; 977/755

(57) ABSTRACT

A fuel cell catalyst layer includes first spaced apart strands extending longitudinally in a first direction, second spaced apart strands extending longitudinally in a second direction, the first and second spaced apart strands collectively defining openings bounded by an adjacent pair of the first spaced apart strands and an adjacent pair of the second spaced apart strands, a number of wires extending longitudinally in a third direction from one of the first and second spaced apart strands, the wires including an organic material, and a catalyst contacting at least a portion of the plurality of wires.

### CROSS-REFERENCE TO RELATED APPLICATIONS

This application is a continuation-in-part of U.S. application Ser. No. 12/770,277 filed Apr. 29, 2010, and a continuation-in-part of U.S. application Ser. No. 12/770,084 filed Apr. 29, 2010.

### TECHNICAL FIELD

The present invention relates to thin film catalyst with heat-extendable wires and an electrode assembly employing the same.

### BACKGROUND ART

While reliability and working lifetime have been considered for utilizing fuel cell (FC) technologies in automotive applications, catalyst activity remains one factor that needs thorough consideration for commercializing fuel cell technologies and in particular fuel cell vehicles. Efforts have been made with a focus on developing fuel cell catalysts having a desirable electro-catalytic oxygen reduction reaction (ORR). To this end, fuel cell catalysts configured as what is known as the core-shell nano-particles, show some improvement over pure platinum nano-particles and/or pure platinum alloys nano-particles supported on carbon. However, these conventional core-shell catalysts, by virtue of being nano-particles, are still prone to agglomeration, dissolution and other durability issues.

### SUMMARY

In one embodiment, a catalytic assembly includes: a porous substrate including a mesh structure and/or an array structure, wherein the mesh structure includes first spaced apart strands extending longitudinally in a first direction, and second spaced apart strands extending longitudinally in a second direction, the first and second spaced apart strands collectively defining openings bounded by an adjacent pair of the first spaced apart strands and an adjacent pair of the second spaced apart strands, wherein the array structure includes a number of spaced apart regions each having a surface and a thickness dimension extending from the surface, the surface including a linear dimension greater than the thickness dimension; a number of wires including an organic material and contacting the substrate; and a catalyst film contacting at least a portion of the number of wires.

The catalyst film may further contact at least a portion of the substrate. At least a portion of the openings may have a geometric shape selected from the group consisting of a rectangular, a square, an oval, a circle, and combinations thereof. At least two adjacent openings may have a same geometric shape. At least a portion of the spaced apart regions may have a geometric shape selected from the group consisting of a rectangular, a square, an oval, a circle, and combinations thereof. At least two adjacent regions may have the same geometric shape.

The catalyst film may have a film surface and a thickness, the film surface contacting the porous substrate, the thickness being of 2 to 20 atomic layers. The film surface of the catalyst film may have a linear dimension of at least 30 nanometers. The catalyst film may contact the substrate continuously along at least 90 percent of the linear dimension of the film surface.

The organic material for forming the number of wires may include N,N′-di(3,5-xylyl)perylene-3,4,9,10 bis(dicarboximide), otherwise referred to as Pigment Red 149 or PR149. The wires may be formed via heat assisted annealing or thermal annealing of the organic material. The formation may further be assisted via the use of vacuum.

### BRIEF DESCRIPTION OF THE DRAWINGS

FIG. 1 is a perspective view of a fuel cell electrode assembly according to one embodiment of the present invention;

FIG. 2A1 is a top plan view of a fuel cell electrode assembly according to one embodiment of the present invention;

FIG. 2A2 is an enlarged view of a section of the fuel cell electrode assembly of FIG. 2A1;

FIG. 2A3 is a schematic cross-sectional view of the section of the fuel cell electrode assembly of FIG. 2A2;

FIG. 2A4 is an enlarged view of the section of FIG. 2A3;

FIG. 2A5 is an enlarged view of a catalyst patch of FIG. 2A2;

FIGS. 3A to 3C are schematics of process steps for forming the fuel cell electrode assembly of FIG. 2A1 according to another embodiment of the present invention;

FIGS. 4A to 4C are schematics of process steps for forming the fuel cell electrode assembly of FIG. 2A1 according to yet another embodiment of the present invention;

FIGS. 5A to 5C are schematics of process steps for forming the fuel cell electrode assembly of FIG. 2A1 according to yet another embodiment of the present invention;

FIGS. 6A-6C schematically depict process steps for forming the fuel cell electrode assembly of FIG. 2A1 according to yet another embodiment of the present invention;

FIGS. 7A to 7C are schematics of process steps for forming the fuel cell electrode assembly of FIG. 2A1 according to yet another embodiment of the present invention;

FIGS. 8A to 8B are schematics of a fuel cell cathode employing the fuel cell electrode assembly of FIG. 2A1 according to yet another embodiment of the present invention;

FIGS. 9A to 9D are schematics of an exemplary fuel cell electrode assembly in the form of a catalyst coated membrane (CCM) according to the example described herein;

FIGS. 10A-10C are schematics of SEM micrographs in increasing magnification of an array of platinum dots supported on a gas diffusion layer (GDL) to form GDE, in contrast to the configuration of a CCM per FIGS. 9A-9D;

FIG. 11A is an enlarged view of a catalyst layer for use in the fuel cell electrode assembly of FIG. 1;

FIG. 11B is an enlarged view of a portion of the catalyst layer of FIG. 11A, the portion containing a plurality of wires extending from a surface of the portion;

FIGS. 12A1-12A2, 12B1-12B2, 12D and 12E1-12E2 illustratively show processes for generating wires on a mesh substrate according to one or more embodiments of the present invention;

FIG. 14B1 is a conventional fuel cell electrode system containing platinum nano-particles supported on carbon;

FIG. 14B2 is an enlarged view of a section of the conventional fuel cell electrode system of FIG. 14B1; and

FIG. 14B3 is an enlarged view of a conventional platinum (Pt) nano-particle of FIG. 14B2.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Also, unless expressly stated to the contrary, the description of a group or class of material as suitable or preferred for a given purpose in connection with the invention implies that mixtures of any two or more members of the group or class may be equally suitable or preferred.

Fuel cells have been pursued as a source of power for transportation because of their high energy efficiency and their potential for fuel flexibility. However, broad commercialization of the fuel cells has been met with many limitations, particularly in relation to the relatively high cost of the fuel cell catalyst. Some of catalyst metals as used in fuel cell applications include noble and transition metals, such as platinum, which are very expensive. An amount of about 0.5 to 4 milligrams per square centimeter precious metals such as platinum is often required for a conventional fuel cell catalyst. It has been estimated that the total cost of the noble metal catalysts is approximately 75 percent (%) of the total cost of manufacturing a low-temperature fuel cell stack.

One source of the high cost of conventional fuel cell catalyst may be due to the insufficient use of the catalyst itself. By way of example, conventional fuel cells employ catalyst in the form of nano-particles supported on porous carbon support. The nano-particles are about 2 to 20 nanometers in diameter, are intrinsically less active than their bulk counterparts. These conventional platinum nano-particles are often provided with several hundred or more atoms and atomic layers of catalyst metals; however, only a few surface atomic layers of the nano-particles are accessible to fuel cell reactants and remain active for electrochemical reaction, while majority of the catalyst layers toward the center of the nano-particle remain essentially inactive. In addition, due to their inherently high surface energy, nano-particles tend to aggregate to form larger particles, and may actually dissolve into the electrolyte membrane and consequently lose surface area and catalytic activities.

Another limitation associated with certain conventional fuel cell system is ineffective flooding control. By way of example, certain reactants including oxygen/hydrogen gas, water, and protons cannot easily move across the catalyst sheet and as a result, little or no electrochemical reaction happens. Moreover, even if some oxygen gas, hydrogen gas, and proton do move across the catalyst sheet, resultant water molecules cannot move across the catalyst sheet and therefore often results in water flooding.

One or more embodiments of the present invention, as will be described in more detail below, alleviate some of the above-identified issues associated with the conventional fuel cell systems.

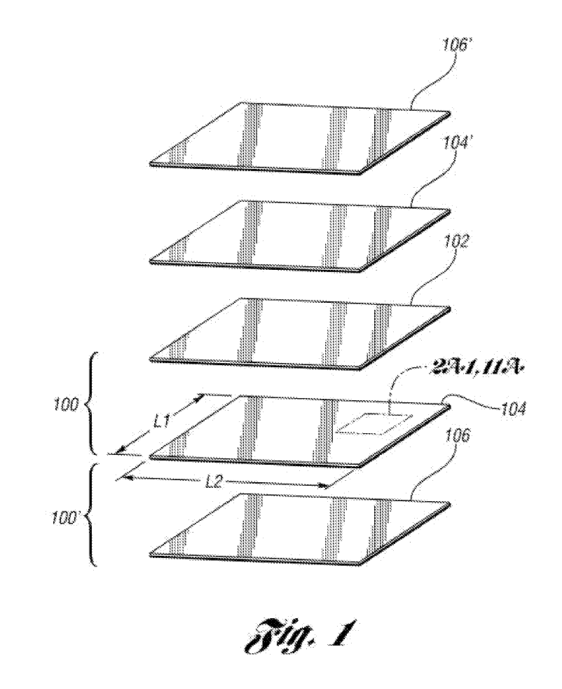

According to one aspect, a fuel cell electrode assembly is provided. In one embodiment, and as depicted in FIG. 1, the fuel cell electrode assembly can be configured for use as a catalyst coated membrane 100 including a proton exchange membrane 102 and a catalytic layer 104. Alternatively, the fuel cell electrode assembly can be used as a gas diffusion electrode 100′ including a gas diffusion layer 106 and the catalytic layer 104. It is noted that the electrode assembly 100, 100′ is equally applicable to the other side of the proton exchange membrane 102, for instance to include a catalytic layer 104′ and a gas diffusion layer 106′ for use as a balance electrode.

The catalytic layer 104, 104′ may be defined by a first surface dimension L1 and a second surface dimension L2, as illustrated in FIG. 1. The first surface dimension L1 may be of a value no less than 1 cm, 2 cm, 3 cm, 4 cm or 5 cm, and no greater than 15 cm, 14 cm, 13 cm, 12 cm, 11 cm or 10 cm. The second surface dimension L2 may be of a value no less than 25 cm, 50 cm, 75 cm, or 100 cm, and no greater than 250 cm, 225 cm, 200 cm, or 175 cm.

The PEM 102 may be made of any suitable polymer electrolyte or its derivatives. Useful polymer electrolytes may include copolymers of tetrafluoroethylene and one or more fluorinated, acid-functional comonomers. In certain instances, polymer electrolytes may include Nafion® (DuPont Chemicals, Wilmington Del.) and Flemion™ (Asahi Glass Co. Ltd., Tokyo, Japan). In addition, liquid electrolytes and solid electrolytes may also be useful.

FIGS. 2A1 and 11A each depict an enlarged view of a portion of the catalytic layer 104 or a portion of the assembly 100, 100′.

In one embodiment, and as depicted in FIGS. 2A1-2A3, a portion of the catalytic layer 104, generally shown at 200, includes a substrate 202 having a substrate surface area illustratively defined by corners c1, c2, c3, and c4, and a plurality of catalyst regions 204 in overlaying contact with the substrate 202 and having a catalyst surface area illustratively defined by the sum of the surface areas of all the catalyst regions 204.

An area differential generally shown at 206 as the un-shaded area in FIG. 2A2 indicates the sum of areas on the substrate 202 that not intentionally placed in contact with the catalyst regions 204. Therefore the area differential 206 is substantially free of any catalyst materials.

The term “substantially free” may refer to an extent of being less than 10 percent, 5 percent, or 1 percent by weight, volume, length or degree, and in some instances means that a substance is not purposefully added and whose presence, if any, is only incidental.

The area differential 206 collectively forms a passage way between the catalyst regions 204. Without being limited to any particular theory, it is believed that water molecules are able to pass by simple diffusion and/or convection mechanism through the non-catalytic area differential 206, or the passageway, on the substrate 202 such as a proton electrolyte membrane (PEM), gaseous reactants and products after passing through the non-catalytic area differential 206 can diffuse to/from the GDL from/to the catalyst regions 204. Consequently, reactant consumption limitations and flooding due to water accumulation at the fuel cell electrode can be effectively reduced.

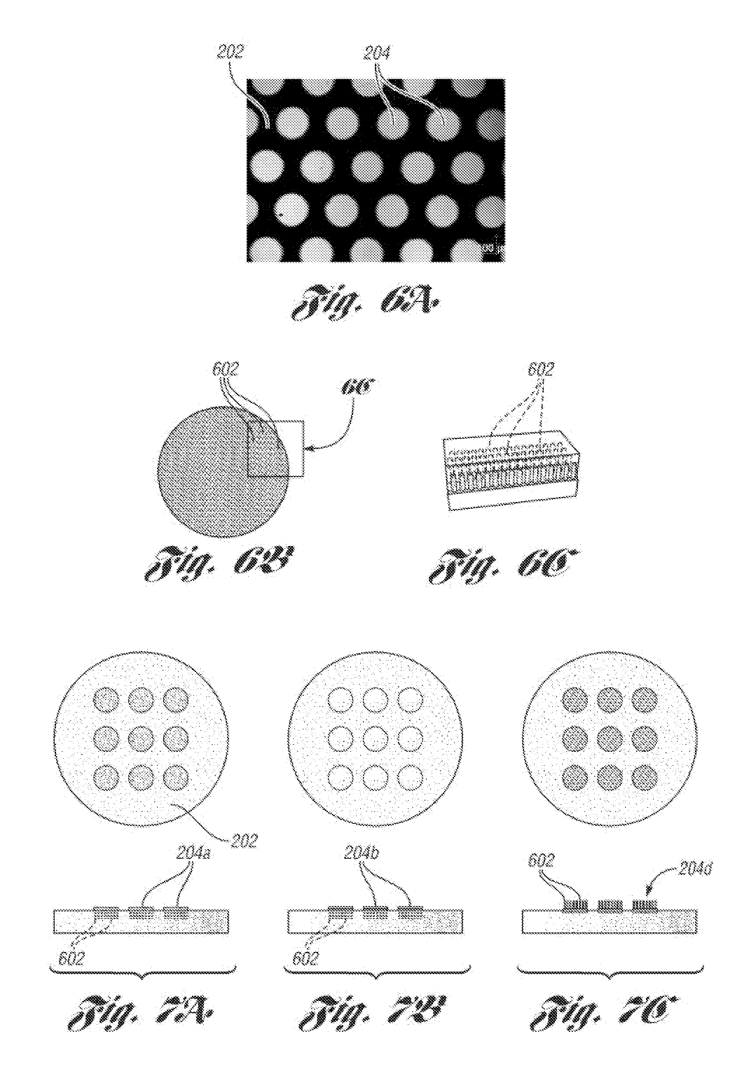

The substrate 202 can be a PEM or a gas diffusion layer (GDL). The catalytic layer 100 can be used in an anode and/or a cathode in a fuel cell. The catalyst regions 204 can be of any suitable geometric shapes and/or any suitable sizes. By way of example, the catalyst regions 204 each can be of the form of a square, a rectangle, a triangle, a circle, a trapezoid, or any combination thereof. In certain instances, the catalyst regions 204 are a plurality of spaced apart circles in an array format as illustratively shown in FIG. 6A.

According to FIGS. 2A1-2A3, the catalyst regions 204 may each provided with an aspect ratio defined by the ratio of the planar liner dimension “m” of the catalyst region 204 of FIG. 2A2 relative to a thickness dimension “z” of the same catalyst region 204 shown in FIG. 2A3. The planar linear dimension is the largest linear distance between any two points on an outer perimeter of the catalyst region 204 and varies with the shape of the catalyst region 204. When the catalyst regions 204 take the shape of a square or a rectangle, the planar linear dimension “m” is the diagonal distance of the square or rectangle. When the catalyst regions 204 take the shape of a circle, the planar linear dimension “m” can be the diameter of the circle. In certain instance, the thickness dimension “z” substantially perpendicular to the planar surface of the substrate 202. In certain other instances, an aspect ratio of the planar linear dimension “m” relative to the thickness dimension “z” of the catalyst regions 204 is greater than 20, 100, 500, 1,000, 5,000, or 10,000.

The term “substantially” may refer to an extent of being greater than 75 percent, 85 percent, or 95 percent by weight, volume, length or degree.

FIG. 2A5 depicts an enlarged top plan view of the catalyst region 204 of FIG. 2A2. As shown in FIG. 2A5, the catalyst region 204 is formed of catalyst metals 212 contiguously aligned next to each other and together forming a substantially planar and connected atomic layer of the catalyst metals 212. In yet another embodiment, and as shown in FIG. 2A2 and 2A5, the catalyst region 204 takes the shape of a rectangle, having a width “x” and a length “y”. It is appreciated that at least one of the width “x” and length “y” is a value greater than or equal to the diameter “d” of a conventional Pt nano-particle 212. In this regard, at least one of the width “x” and the length “y” is greater than 20 nm, 50 nm, 100 nm, or 150 nm. In certain instances, “x” can be as small as a catalyst atom diameter, while “y” can be any suitable length to provide the desirable catalytic surface area, and “z” can take any suitable value. The term “substantially planar and connected atomic layer” may refer to an arrangement of catalyst metals 212 in a substantially planar continuum film, wherein the term “continuum” refers to a continuous extent, succession, or whole, no part of which can be distinguished from neighboring parts except by arbitrary division, and wherein the term “substantially planar” refers to that no less than 75 percent, 85 percent, or 95 percent by area of the atomic layer 210 is parallel to the planar surface of the substrate 202. U.S. patent application titled “Catalyst Layers Having Thin Film Mesh Catalyst (TFMC) Supported on a Mesh Substrate and Methods of Making the Same” with Ser. No. of 12/495,839, provides a detailed description of the “continuum” or “thin film” atomic layers of catalyst metals, the entire contents thereof are incorporated herein by reference.

Unlike Pt atoms 1424 contained within the conventional Pt nano-particles 1422 wherein the Pt atoms 1424 are randomly packed with a large number of under-coordinated Pt atoms and being in an unstable energy state, the catalyst atoms 212 contained within the substantially planar continuum film 210, as illustratively depicted in FIG. 2A4, together form a continuum as they have attained their desirable coordination number and relatively low surface energies mimicking catalyst metals in bulk. For instance catalyst metal atoms in bulk are properly bonded to each other such that under-coordinated atoms as exist in nano-particles are not found in bulk and this brings to the bulk catalyst with lower surface energy and more resistant to catalyst dissolution.

The catalyst regions 204 can be provided with any suitable thickness dimension “z”. By way of example, the catalyst regions 104 can take up a thickness dimension “z” corresponding to 1 to 250 atomic layers 110, 1 to 200 atomic layers 210, 1 to 100 atomic layers 210, 1 to 50 atomic layers 210, or 1 to 20 atomic layers 210. The adaptability of the catalytic layer 200 to be used for providing the catalyst regions 204 having no more than 20 atomic layers of the catalyst metals 112, as described herein and according to one or more embodiments of the present invention, presents a clear departure from the conventional Pt nano-particles 1422 wherein on an average more than 20 Pt atomic layers, and in certain instance more than 200 Pt atomic layers, are involved in each nano-particle 212. These conventional catalyst nano-particles often have a large number of under-coordinated Pt atoms due to high curvature inherent to the nano-particles. In the arrangement as described herein, the catalytic layer 200 can be constructed with a significantly reduced consumption of the costly catalyst metals 212 such as platinum group metals. Because the catalyst regions 204 are provided with just the amount of atomic layers of the catalyst metals 212, for instance 1 to 20 atomic layers, needed by and accessible to the fuel cell reactants, the fuel cell electrode assembly 100 is thus configured to reduce the precious catalyst metal consumption without having to sacrifice electrochemical performance of a resultant fuel cell. Moreover, each atom 212 (FIG. 2A4), by virtue of being part of a catalyst region 204, is intrinsically more active than each atom 1424 in the conventional nano-particle 1422. Therefore, fewer catalyst atoms are needed which in turn reduces the consumption of precious catalyst metals.

As depicted in FIGS. 5A-5C, the catalyst regions 204 may be arranged to have a core-shell configuration, wherein a catalyst core layer 204b is disposed between two catalyst shell layers 204a, 204c. The catalyst core layer 204b illustratively include relatively less precious metals such as any suitable base metals including cobalt, nickel, copper, iron, yttrium, their oxides, polymer, plastic, or combinations thereof. When used, the polymer is believed to assist the proper orientation of the catalyst metals as deposited in forming the shell layers 204a, 204c. In particular, substrate material can promote growth of catalyst metals in (111), (100), or other desirable orientations. The catalyst shell layers 204a, 204c illustratively include relatively more precious catalyst metals including one or more platinum group metals, their oxides, or combinations thereof. In certain instances, the core-shell catalyst regions 204 include Pt₃Co, Pt₃Cu, Pt₃Ni, and combinations thereof. In certain particular instances, the core-shell catalyst regions 204 include Pt₃Ni alloys. It is noted the present invention is not limited to the types of the core-shell catalyst employed, rather any binary, ternary, quarterly, or other suitable forms of the relatively more precious metals for the shell and the relatively less precious metals and/or polymers for the core can be used. Core-shell catalyst have been studied in the form of nano-particles and for the reasons stated herein in relation to catalyst nano-particles, conventional core-shell catalysts are also prone to degradation and relatively lower activities. The core-shell catalysts described within the context of one or more embodiments of the present invention are in the form of thin film catalyst with much lowered surface curvature in comparison to conventional core-shell nano-particles.

The catalyst regions 204 may be substantially free of carbon black or other carbon containing materials. In certain instances, the catalyst regions 204 and/or the area differential 206 contain less than 5 weight percent, 4 weight percent, 3 weight percent, 2 weight percent, 1 weight percent, 0.5 weight percent, or 0.05 weight percent of carbon black. Without being limited by any particular theory, it is believed that carbon black or porous carbon can assist in reactants transport and water management, and provide electronic conductivity. In addition, carbon black or porous carbon can be applied as an ink. Other suitable additives that may adjust and control the hydrophobicity and proton conductivity in catalyst layer, such as Teflon™, proton conducting ionomers, can also be used.

As depicted in FIGS. 6A-6C, any one of the catalyst regions 204 can be configured to include a plurality of wires 602 extending substantially longitudinally from the substrate 202. FIG. 6B depicts an enlarged view of one of the catalyst regions 204 of FIG. 6A. FIG. 6C depicts a further enlarged view of the catalyst patch 204 of FIG. 6B, showing wires extending longitudinally from the substrate 202. The wires 602 can be formed via methods described herein elsewhere.

The term “wires” or “nanowires” may be used interchangeably. The term “nanowire” does not necessarily indicate the wires are of dimensions in nanometer scale. The wires or the nanowires may have an average diameter in nanometer scale and/or an average length in micrometer scale.

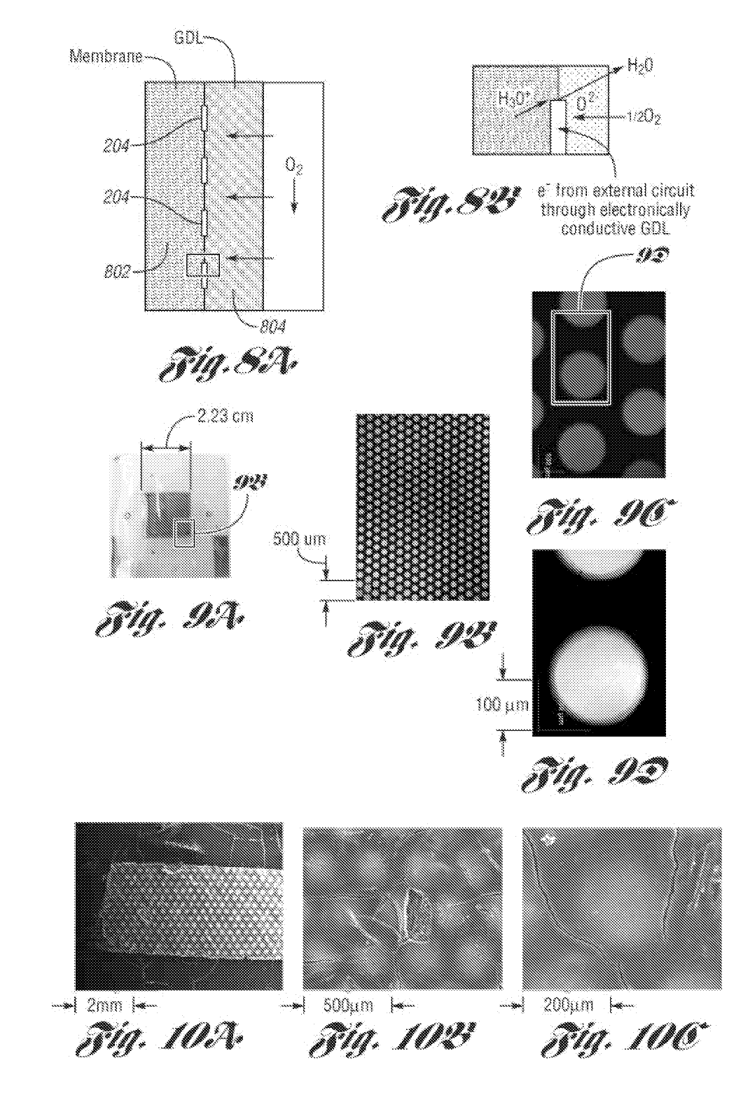

As depicted in FIGS. 7A-7C, the catalyst regions 204 can be arranged to have a core-shell configuration similar to that in relation to FIG. 5A-5C, combined with a layer of wires 204d which can be formed according to FIGS. 6A-6C. Consequently, the catalyst regions 204 according to FIGS. 7A-7C are provided with a first catalyst shell layer 204a which is in overlaying contact with the substrate 202, a core layer 204b, and a second catalyst shell layer 204d configured to include a plurality of wires 602 extending longitudinally in a thickness direction or in a direction substantially transverse to a planar surface of the substrate 202.

As shown in FIGS. 7A-7C, the first catalyst layer 204a can also be similarly configured, like the second catalyst layer 204c, to include a plurality of wires 602 extending longitudinally in a thickness direction or in a direction substantially transverse to the planar surface of the substrate 202. In this configuration, the plurality of wires 602 as present on the first catalyst layer 204a and the plurality of wires 602 on the second catalyst layer 204c are directed away from each other.

The wire 602 can be pre-coated with a different material such as polymer and/or metal oxides. The catalyst that is later deposited onto the pre-coated wire 602 is expected to have preferred crystalline orientation and improved activity.

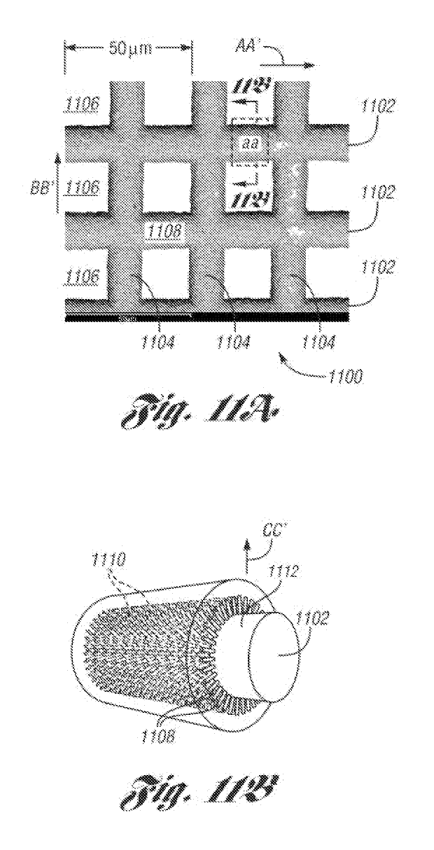

As depicted in FIGS. 8A-8B, the catalyst regions 204 having the core-shell configuration according to FIGS. 7A-7C can be disposed between a PEM 802 and a GDL 804, wherein the first and second catalyst shell layers of the catalyst regions 204 are in contact with the PEM 802 and the GDL 804 respectively.

Unlike conventional carbon-supported fuel cell catalyst wherein catalyst metals are present in discrete nano-particles such as one illustratively shown in FIGS. 14B1-14B2, wherein electronic connection between the discrete particles is provided through the carbon support material, the catalyst metal atoms of the catalyst regions 204 having catalyst atoms presented in a continuum film can substantially be connected to each other electronically without the need for an intermediate connecting medium such as carbon.

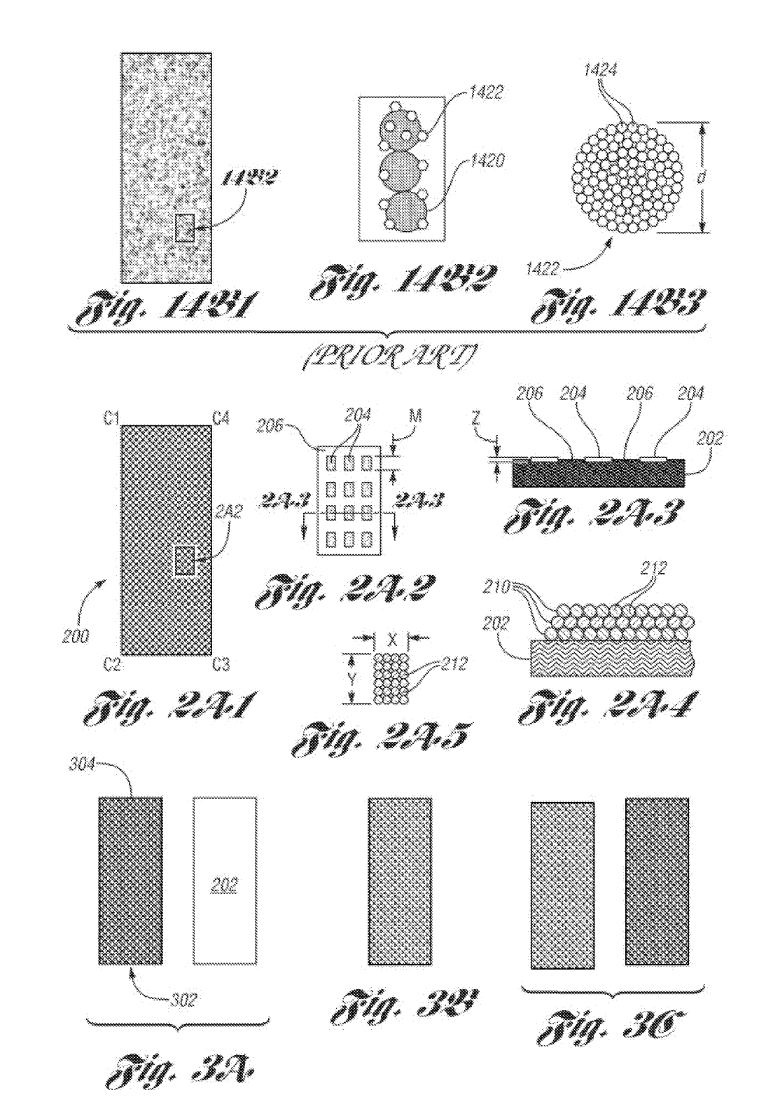

In another aspect, a method is provided for forming the catalytic layer 100. In one embodiment, and as depicted in FIGS. 3A-3C, the method includes overlaying a substrate 202 with a masking screen 302 having a plurality of openings 304, through which catalyst metals can be deposited onto the substrate 202 to form the catalyst regions 204. A specific example of the method is provided in the Example section.

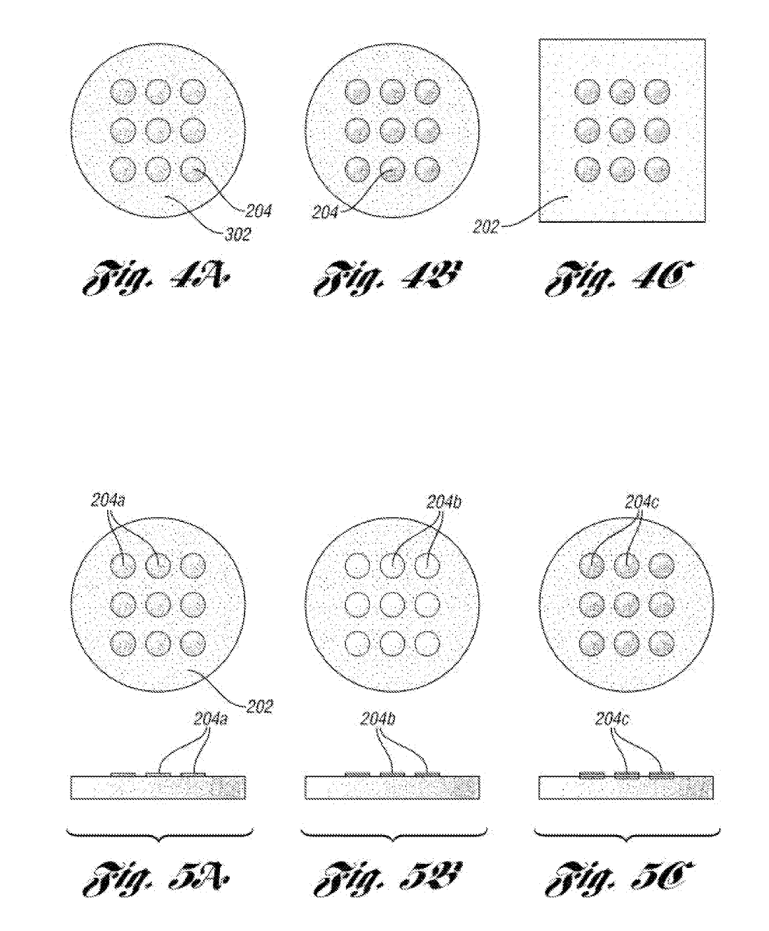

As depicted in FIGS. 4A-4C, the method may include depositing catalyst metals onto an intermediate support 402 to form the catalyst regions 204, wherein the intermediate support 402 can be silica based or of other thermally stable materials. Subsequently, the catalyst metals are subject to an annealing process per FIG. 4B wherein catalyst metal alloys are arranged via the annealing process to present the desirable catalytic properties. The catalyst regions 204 thus formed are then transferred onto the substrate 202 via a decal process per FIG. 4C to form the catalytic layer 100. This method is particularly useful when the catalyst regions 204 are formed of metal alloys, such as the highly active platinum nickel alloy, Pt₃Ni.

A masking screen, such as the masking screen discussed herein in the Examples, may be used to deposit a layer of polymer material such as PR149 such that patches of PR149 can be formed where the patches 204 are located and the patches of PR149 can then be subjected to thermal annealing to form the heat extendable hairs such as the hairs 602.

An array of patches (not shown) resembling the catalyst regions 204 can be used to imprint or emboss the substrate 202 to create impression, upon which the catalyst metals 212 can be directly deposited to create the catalyst regions 204. Alternatively, the array of patches may also include wires 602, together they can be used to imprint or emboss the substrate 202 to create impression, upon which the catalyst metals 212 can be directly deposited.

Referring back to FIGS. 2A1-2A3, the area differential 206 is provided for passing certain fuel cell reactants. The area differential 206 allows direct or facile passage of protons/water and gases through the openings provided therein, while transfer of electrons to and from the reaction site may take place rapidly through the continuous conductive thin film of catalyst to or from the GDL. As used herein, in one or more embodiments, the term “fuel cell reactants” refers to gases and liquids ordinarily involved in a fuel cell electrochemical reaction. Fuel cell reactants include many species depending upon the fuel cell type. Examples of the hydrogen fuel cell reactants include oxygen gas, hydrogen gas, oxygen ions, hydrogen ions, and water molecules.

The catalyst regions 204 may take any suitable geometric shapes. Non-limiting examples of the shapes include circles, squares, rectangles, triangles, and trapezoids.

The wires 602 can be made of any suitable materials, including gold, ceramics, nickel, steel, copper, iron, cobalt, chromium, plastics, polymers, and combinations thereof.

The catalyst regions 204 contain catalyst metals arranged as a catalyst continuum film. The catalyst continuum film can be configured to have any suitable thickness for an intended design. In certain instances, the platinum continuum film can be formed of 1 to 20 atomic layers. A total thickness of the platinum continuum film is in a range of 0.1 to 500 nanometers, 2 to 450 nanometers, 10 to 400 nanometers, or 25 to 350 nanometers. In general, the thinner the continuum film, the less the catalyst loading and expenditure. However, it should be noted that the thickness of the continuum film of the catalyst regions 204 does not restrict in any way the practice of the present invention. The thickness of the continuum film may be controlled to provide a desirable loading of the metallic catalyst. The thickness can be optionally controlled by using the core-shell structure wherein the non-precious core can be made of any desirable thickness followed by a coating of shell catalyst.

The catalyst regions 204 may include catalyst metals 212 configured as single crystalline, polycrystalline, or combinations thereof. In the event that the single crystals of platinum are used, the single crystals of preference are characterized as having (111), (100) and/or (110) facets. In certain particular instances, the single crystals are each provided in the thickness direction with 1 to 20 atomic layers, such that precious catalyst metals can be effectively used. Alternatively, in the event that the polycrystalline crystals are used, the preferred polycrystalline for platinum or platinum containing alloys is characterized as having (111) facets and (100) tops. The performance of the (100) and (111) crystal surface of bulk catalyst metal such as platinum is far superior to conventional platinum nano-particles. Because the catalyst such as platinum can be grown in single crystals and configured as a thin continuum film on the mesh substrate having nanowires, this catalyst behaves more like the bulk metal catalyst with preferred crystalline structure and is provided with relatively higher catalytic activity per a given surface relative to the catalyst in conventional nano-particle configuration, thereby reducing precious catalyst consumption.

The catalyst regions 204 can be mass produced using stamping or electro-deposition techniques for micro- or nano-fabrication. Non-limiting stamping methods are disclosed in Mirkin et al., “Emerging methods for Micro- and nanofabrication”, MRS bulletin, July 2001; Walker et al. “Growth of thin platinum films on Cu (100): CAICISS, XPS and LEED studies”, Surface Science 584(2005) 153-160; and Y. Xia et al., “Unconventional methods for fabricating and patterning nano structures,” Chem. Rev., 1999, vol. 99, pp 1823-1848. The entire contents of these methods are incorporated herein by reference. Nanofabrication methods, such as soft lithography have also been used to transfer an array of openings to a metallic thin film of gold with thickness of 100 nanometers (nm). Non-limiting nanofabrication methods are disclosed in “Patterned transfer of metallic thin film nanostructures by water-soluble polymer templates” authored by C. D. Schaper, Nano Lett., Vol. 3, No. 9, pp 1305-1309, 2003, the entire contents thereof are incorporated herein by reference.

Vacuum deposition techniques, preferably electron beam physical vapor deposition (EB-PVD) or RF sputtering, may be used to deposit, atom by atom, the catalyst metals for forming the catalyst regions 204. Any suitable stamping techniques for micro or nano-fabrication applications can be used to manufacture the mesh substrate support according to one or more embodiments of the present invention. For instance, nanofabrication methods, such as soft lithography can be used to illustratively transfer a pattern of catalyst regions such as region of 204 of a metallic thin film to a GDL or a PEM.

As described herein above, one or more embodiments of the present invention can reduce catalyst dissolution. Although not intending to be bound to any particular theory, degradation due to particle dissolution may be reduced since catalyst metals presented as a continuum film are intrinsically more stable than conventional catalyst nano-particles due to the lower surface energy associated with films. Moreover, catalyst agglomeration inherent in conventional carbon-supported catalyst nano-particles can be effectively reduced. Degradation due to particle agglomeration may also be reduced.

A further advantage of one or more embodiments of the present invention is a reduction or elimination of carbon materials in the catalyst regions. As a result, issues such as carbon support corrosion and large Ohmic losses for electron transfer through carbon support may be reduced because of the reduction of carbon materials used to support the catalyst metals. Furthermore, peroxide formation that degrades membranes is significantly reduced.

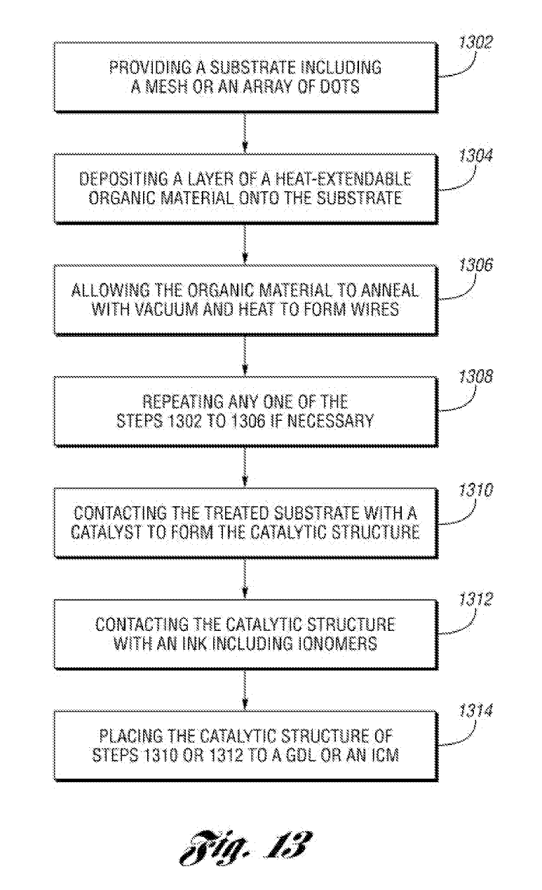

In a variation, FIG. 11A depicts another enlarged view of a portion of the catalytic layer 104 or a portion of the assembly 100, 100′. FIG. 11A includes first spaced apart strands 1102 extending longitudinally in a first direction AA′ and second spaced apart strands 1104 extending longitudinally in a second direction BB′, forming an interconnected network defining a number of openings 1106. FIG. 11B depicts an enlarged view of a section “aa” of the interconnected network 1100 of FIG. 11A, showing secondary structures, for instance, a plurality of wires 1110 extending longitudinally from a surface 1112 of the strand 1102 in a third direction CC′. In certain instances, the wires 210 extend radially from the surface 1112 as shown in FIG. 11B. The catalytic layer 104 further includes a catalyst 1108 in overlaying contact with at least a portion of the first and second spaced apart strands 1102, 1104. In certain particular instances, the catalyst 1108 is configured as a continuum film as described herein elsewhere in relation to FIG. 2A4.

The wires 1110 can be interchangeably referred as the wires 602 described in relation to FIG. 6C. In addition, wires or nanowires 1110 may be grown on both planar sides of the interconnected network 1100 to provide additional catalytic surface area.

Two or more planar layers of the interconnected network 1100 may be aligned next to each other to provide additional catalytic surface area.

The catalytic layer 104 may not need a stand-alone interconnected network 1100 for support and instead can be directly supported on the substrate 102, 106, or 106′. In this arrangement, an interconnected network or mesh 1100 described herein can be used to imprint or emboss the substrate to form a corresponding impression on the substrate. The interconnected network 1100 can then be removed. The catalyst 1108 can be deposited directly onto the impression area of the substrate. The interconnected network 1100 can be made of any materials and for economical efficiency is made of relatively cheap metals such as copper, nickel, or iron. In addition, the interconnected network 1100 can be provided to have the wires 1110 extending therefrom and the resultant structure can be used to imprint or emboss the substrate.

The mesh substrate, metallic, non-metallic, or combinations thereof may form the base to support the wires. The mesh substrate can be further designed to provide high catalytic surface area for fuel cell electrochemical reactions, thereby maximizing the triple phase boundaries among the catalyst, the ionomer, and the gases. The mesh substrate support allows facile passage of protons/water and gases through the openings provided therein, while transfer of electrons to and from the reaction site may take place rapidly through the continuous conductive thin film of catalyst or mesh substrate.

The openings 1106 may be of any suitable shapes, including the shapes of a rectangular, a square, an oval and a circle.

The openings 1106 may be configured to have an average planar linear dimension of 10 to 70 micrometers, wherein the planar linear dimension is the largest linear distance between any two points on the perimeter of each of the openings 1106. Without being limited to any particular theory, it is believed that the openings thus sized further improves water management by limiting water accumulation in and around the affected openings 1106 and thereby reducing the propagation of the flooding into neighboring openings 1106.

The openings 1106 may further be configured to be filled with a reagent selected from the group consisting of an ionomer, porous carbon, Teflon® and combinations thereof to assist with water management and transport of protons, electrons, and/or other fuel cell reactants.

The catalytic layer 104 may further include an intermediate material (not shown) contacting at least a portion of the first spaced apart strands 1102, the second spaced apart strands 1104, and the wires 1110, wherein the catalyst 1108 is formed on the intermediate material and directed away from the first and second spaced apart strands and the wires. The intermediate material can be a polymer to promote the proper atomic orientation of the catalyst 1108. In certain instances, the polymer is in lattice communication with the catalyst 1108. The intermediate material can be in electronic communication with the catalyst 1108 for fine tuning catalytic activity and enhancing electronic interactions with the first spaced apart strands 1102, the second spaced apart strands 1104, and/or the wires 1110. Non-limiting examples of the electronically active intermediate material may include magnesium oxide, zirconium oxide, niobium oxide, molybdenum oxide, or combinations thereof. Non-limiting examples of the polymers include polyamides such as Kapton from Dupont, polyesters, and polyaramids. Non-limiting examples of the intermediate material may include magnesium, zirconium, niobium, molybdenum, aluminum, cobalt, copper, nickel, tantalum, tungsten, iron, titanium, their oxides, or combinations thereof. Non-limiting examples of the intermediate material may also include semi-conductors such as germanium, silicon, or their oxides; and organic materials such as polynuclear aromatic hydrocarbons, heterocyclic aromatic compounds. Chapters 30 and 31 of “Organic Chemistry” by Morrison and Boyd, 3^{rd} edition, Allyne and Bycon, 1974, provide a good description of the heterocyclic aromatic compounds, the entire contents thereof are incorporated herein by reference.

Unlike conventional fuel cell catalyst which is either supported on carbon particles embedded in a gas diffusion layer or supported on an electrolyte membrane, the catalyst 1108 can be introduced into the fuel cell compartment as a separate layer supported on a mesh substrate as an interconnected network having thereupon catalyst-containing nanowires.

The openings 1106 may be provided for passing certain fuel cell reactants and may be filled with ionomers as described herein in relation to FIG. 2A3.

Whether the openings 1106 should be filled with ionomers is a matter of design. If the openings 1106 are filled with ionomer, the ionic charge carriers and/or protons may be carried out to the catalyst layer adjacent to GDL layer where the electrochemical reaction can happen. This design may be appropriate if the interconnected network or mesh 1100 is relatively thick wherein the presence of ionomers can offset the relatively longer passage the ionic charge carriers and/or protons are to travel from one side of the interconnected network or mesh 1100 to the other. This design may also be more appropriate for low temperature fuel cells where the product water can form droplets that can be removed through GDL. If the openings are not filled with ionomer, the reactive gases must diffuse down the hole to reach the ionic charge carrier- and/or proton-rich membrane in order for the reaction to happen.

The interconnected network 1100 may be provided with a porosity of from 25 to 75 percent, or more particularly from 35 to 65 percent. As used herein, the term “porosity” refers to a fraction of the void spaces defined by the one or more openings in the catalyst layer. Within this regard, the porosity is a function of size, shape and numbers of openings and grids, and thickness of the mesh 1100. As a combination parameter, the porosity may be adjusted to accommodate a particular catalyst loading requirement suitable for certain applications. In addition, when the mesh 1100 is relatively thick, an effective catalytic active area of the catalyst layer may be further increased by growing or depositing catalyst on the inside walls (e.g., perpendicular to the facile plane of the mesh 1100) of the openings without having to necessarily increase or decrease the porosity of the catalyst layer 1112.

The first and second spaced apart strands 1102 and 1104 can be made of any suitable materials, including gold, ceramics, nickel, steel, copper, iron, cobalt, chromium, plastics, polymers, and combinations thereof. The surface of the first and second spaced apart strands 1102 and 1104 can be provided with surface features to better accommodate catalyst film growth for the desired crystalline structure.

In certain instances, the wires 1110 and 602 may be formed of perylene red, an organic material. In this connection, a layer of perylene red may be deposited onto the mesh substrate and the layer of perylene red is subjected to an elevated temperature wherein the perylene red anneals under heat to form a number of wires having an average aspect ratio of greater than 1. U.S. Patent document 2008/0020923 provides a good description as to how a heat-extendable organic material such as perylene red may be used to form the wires 1110 and 602, the contents thereof are incorporated herein in its entirety. As annealed, the mesh substrate may have thereupon the wires 1110 and 602 in a range from about 10⁷ to 10¹¹ per cm².

A layer of perylene red may be applied by physical vacuum vapor deposition, via for instance, sublimation of the organic material under an applied vacuum). The thickness of the perylene red layer may be in the range from about 0.03 to about 0.5 micrometers. The layer of perylene red may be annealed in a vacuum with an elected temperature to permit the perylene red to grow into crystalline structures in the form of wires 201. The vacuum can be of suitable values. A non-limiting example of the vacuum is less than about 0.1 Pascal. The elevated temperature can be of any suitable values. A non-limiting example of the elevated temperature includes a temperature from about 160 to 270 degrees Celsius.

Useful organic materials for forming the wires 1110 and 602 include, for example, planar molecules including chains or rings over which it-electron density is extensively delocalized. These organic materials generally crystallize in a herringbone configuration. Non-limiting examples of the organic materials for forming the wires 1110 and 602 include polynuclear aromatic hydrocarbons and heterocyclic aromatic compounds such as naphthalenes, phenanthrenes, perylenes, anthracenes, coronenes, and pyrenes. A particularly useful organic material is N,N′-di(3,5-xylyl)perylene-3,4,9,10 bis(dicarboximide), alternatively named the pigment red 149 or PR 149.

A non-limiting example of forming a catalyst substrate is depicted in FIG. 13. At step 1302, a substrate including a mesh and/or an array of dots is provided. At step 1304, a layer of an organic material is deposited onto the substrate. At step 1306, the organic material is subjected to vacuum and heat to allow the organic material to anneal, resulting in the formation of elongated wire structures of the organic material. The substrate can be made robust enough such that the entire substrate along with the organic material can be subjected to the vacuum and the heat for the annealing process. After that, the annealing step 1306 may be repeated to increase length of the resulting wires, both step 1304 and 1306 may be repeated to apply a second new layer of the organic material, or all steps 1302 to 1306 may be repeated to apply a second new substrate with the organic material. At step 1310, the resultant substrate with the wires is contacted with a catalyst thin film to form a catalytic structure. At step 1312, the catalytic structure can then be coupled with a gas diffusion layer (GDL) or an ionic conducting membrane (ICM) to form an electrode structure.

The organic material can be applied to the substrate via any suitable methods. Non-limiting examples of the method include submerging the substrate into a solution of PR149 or a solution of PR149 can be sprayed onto the substrate.

The catalyst 1108 such as a platinum continuum film can be configured to have any suitable thickness for an intended design. In certain instances, the platinum continuum film can be formed of 1 to 20 and preferably 4 to 10 atomic layers. A total thickness of the platinum continuum film is in a range of 0.1 to 500 nanometers, 2 to 450 nanometers, 10 to 400 nanometers, or 25 to 350 nanometers. In general, the thinner is the mesh, the less is the cross resistance or the ohmic loss. However, it should be noted that the thickness of the mesh 200 does not restrict in any way the practice of the present invention. The thickness of the mesh 1100 may be controlled to provide a desirable loading of the catalyst 1108.

The metallic catalyst 1108 may include catalyst metals configured as single crystalline, polycrystalline, or combinations thereof. In the event that the single crystals of platinum are used, the single crystals of preference are characterized as having (110) and/or (111) facets. In certain particular instances, the single crystals are each provided in the thickness direction with 1 to 20 atomic layers and particularly 1 to 12 atomic layers, such that precious catalyst metals can be effectively used. Alternatively, in the event that the polycrystalline form of materials are used, the preferred polycrystalline for platinum or platinum containing alloys is characterized as having (111) facets and (100) tops. The performance of the (100) and (111) crystal surface of bulk catalyst metal such as platinum is far superior to conventional platinum nano-particles. Because the catalyst such as platinum can be grown in single crystals and configured as a thin continuum film on the mesh substrate having nanowires, this catalyst behaves more like the bulk metal catalyst with preferred crystalline structure and is provided with relatively higher catalytic activity per a given surface atom relative to the catalyst on surface atom in a conventional nano-particle configuration.

The catalyst 1108 may be configured to be the Pt-skin in a core-shell structure of Pt₃Ni. The Pt-skin in the core-shell catalyst can be formed of Pt atoms arranged in atomic layers as described herein and behave more like metal atoms in bulk. Stamenkovic et al., titled “surface composition effects in electrocatalysis: kinetics of oxygen reduction on well-defined PtNi and PtCo alloy surfaces,” Journal of Physical Chemistry B; 2002, 106(46), 11970-11979, discloses the aforementioned concept of bulk metal catalyst, the entire contents thereof are incorporated herein by reference.

Stamenkovic et al., titled “Improved Oxygen Reduction Activity on Pt₃Ni(111) via Increased Surface Site Availability,” Science, vol. 315, 2007, the entire contents thereof being incorporated herein by reference, discloses that metal atoms in bulk such as Pt₃Ni(111) are approximately 90 times more active than platinum nano-particles on carbon with almost two orders of magnitude improvement. Pure bulk platinum is known to have almost 10 times more activity per catalyst surface area than the Pt nano-particles. Therefore, with the continuum or thin film configuration of the catalyst metals such as the Pt metal atoms arranged in the Pt-skin for the core-shell catalysts, the present invention in one or more embodiments enables the performance of catalyst metal more like metal atoms in bulk and therefore more active than the conventional Pt on carbon nano-particles. Conventional systems in utilizing Pt₃Ni catalyst in fuel cells are met with challenges of creating catalyst bulk having electronic and morphological properties similar to bulk Pt₃Ni(111). Given that the catalyst 208 can be configured as thin continuum film which is grown into well-defined crystalline surfaces, the incorporation of bulk Pt₃Ni(111) to fuel cells can be realized and practiced with greater certainty.

One example of the core-shell substructures that can be employed in the metallic catalyst according to one or more embodiments of the present invention is illustratively shown in Zhang et al., titled “platinum monolayer on nonnoble metal-metal core-shell nanoparticle electrocatalysts for O₂ reduction,” Journal of Physical Chemistry B, 2005, 109(48), 22701-22704, the entire contents thereof are incorporated herein by reference.

Deposition of catalyst atoms for forming the metallic catalyst 1108 can be accomplished by sputtering using vapor deposition, atomic layer deposition, PVD, CVD, electro-deposition, and colloidal methods. Due to the relatively lower surface energy inherent within the continuum film of catalyst atoms, the resultant catalyst layer is provided with relatively higher stability and activity. Thus, the concept of bulk metal catalyst (“surface composition effects in electrocatalysis: kinetics of oxygen reduction on well-defined PtNi and PtCo alloy surfaces;” Stamenkovic et al., Journal of Physical Chemistry B; 2002, 106(46), 11970-11979) that is 5-10 times more active relative to catalyst of nano-particles can be effectively employed in the TFNW according to one or more embodiments of the present invention.

Deposition of catalyst atoms for forming the catalyst 1108 can be accomplished by sputtering using vapor deposition, atomic layer deposition (ALD), PVD, CVD, electro-deposition, and colloidal methods. Due to the relatively lower surface energy inherent within the continuum film of catalyst atoms described herein according to one or more embodiments of the present invention, the resultant catalyst 1108 is provided with relatively higher stability and activity. Thus, the concept of bulk metal catalyst such as the bulk metal construction of Stamenkovic et al. referenced herein can be effectively employed in the catalyst 1108 according to one or more embodiments of the present invention.

The interconnected network 1100 upon which the catalyst 1108 can be deposited can be mass produced using stamping/electrodepositon techniques for micro- or nano-fabrication. Exemplary stamping methods may be had according to Mirkin et al. “Emerging methods for Micro- and nanofabrication”, MRS bulletin, July 2001; and Walker et al. “Growth of thin platinum films on Cu (100): CAICISS, XPS and LEED studies”, Surface Science 584(2005) 153-160. Nanofabrication methods, such as soft lithography have also been used to transfer a mesh pattern of openings to a metallic thin film of gold with thickness of 100 nanometers (nm). As such, the mesh substrate having nanowires can be used to support the continuum film of the metallic catalyst to form the fuel cell catalyst layers. Non-limiting nanofabrication methods are disclosed in “Patterned transfer of metallic thin film nanostructures by water-soluble polymer templates” authored by C. D. Schaper, Nano Lett., Vol. 3, No. 9, pp 1305-1309, 2003, the entire contents thereof are incorporated herein by reference.

Vacuum deposition techniques, preferably electron beam physical vapor deposition (EB-PVD) or RF sputtering, may be used to deposit, atom by atom, the catalyst metals for forming the catalyst 208. Any suitable stamping techniques for micro or nano-fabrication applications can be used to manufacture the mesh substrate support according to one or more embodiments of the present invention. For instance, micro- or nano-fabrication methods, such as soft lithography, can be used.

It is an advantage, and as described herein above, that catalyst dissolution common to conventional catalyst nano-particles can be effectively reduced through the implementation of continuum film of metallic catalyst, according to one or more embodiments of the present invention. Degradation due to particle dissolution may be removed since catalyst metals presented as a continuum film is intrinsically more stable than conventional catalyst nano-particles due to the lower surface energy associated with films. Moreover, catalyst agglomeration inherent in conventional carbon-supported catalyst nano-particles can be effectively reduced. Degradation due to particle agglomeration may be removed. The catalyst layer based on metallic thin film does not contain particles and the surface properties of thin films more resemble that of the bulk catalyst than nano-particles.

It is a further advantage, and according to one or more embodiments of the present invention, that carbon support for the catalyst layers can be reduced or eliminated. As a result, issues such as carbon support corrosion and large Ohmic losses for electron transfer through carbon support may be avoided since essentially no carbon is necessarily used to support the catalyst in TFNW concept. Furthermore, peroxide formation that degrades membranes is significantly reduced.

Having generally described this invention, a further understanding can be obtained by reference to certain specific examples which are provided herein for purposes of illustration only and are not intended to be limiting unless otherwise specified.

### EXAMPLES

### Example 1

### An Illustrative Method for Forming a Fuel Cell Catalyst Assembly as Described Herein

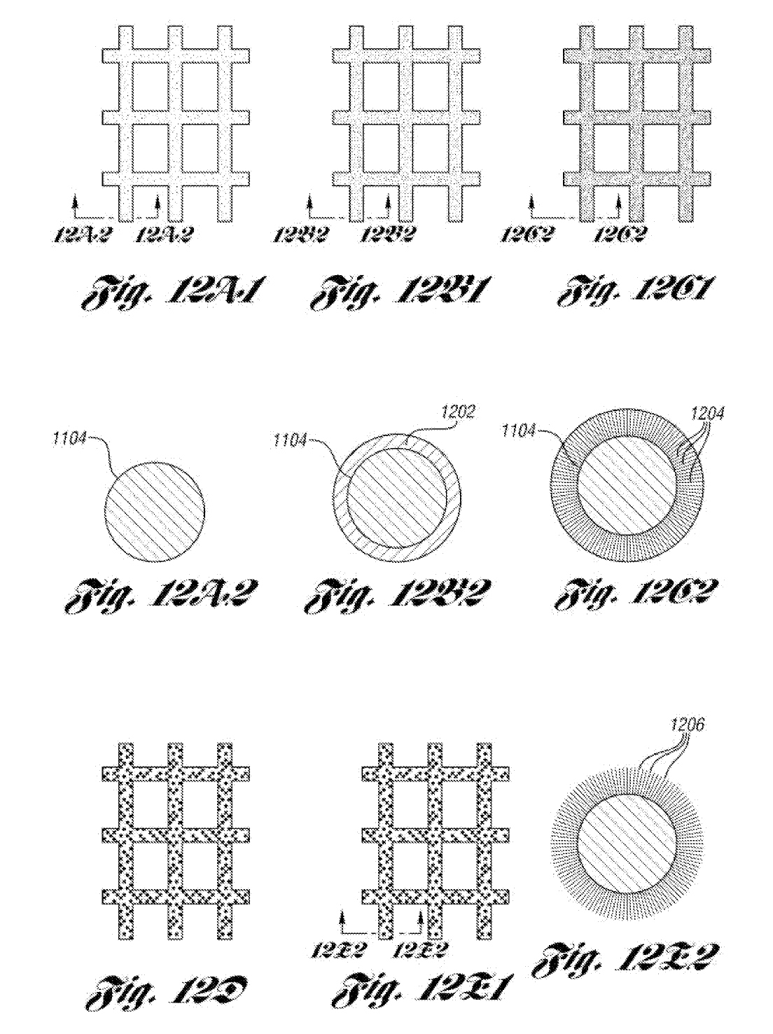

FIGS. 3A-3C schematically depict process steps for forming the fuel cell electrode assembly of FIG. 1A1 according to one or more embodiments of the present invention. As depicted in FIGS. 3A-3C, vacuum sputtering is used to deposit platinum dots as a particular form of the catalyst regions 304 onto the substrate 202, either a PEM or a GDL. A stainless steel perforated sheet is used as a masking screen. The stainless steel perforated sheet has holes of diameter 152 micrometers with a staggered pattern having a center to center spacing of 285 micrometers and a thickness of 127 micrometers. The thickness of platinum deposit is 2.5 nanometers. The array of catalyst regions 104 is generated on both a 1200-W series GDL from E-Tek and 112 Nafion membrane from Dupont. A commercially available design for serpentine flow field from Fuel Cell Technologies (FCT) with 5 cm² active area is used for the anode and the cathode. A conventional GDE from E-TEK (12-W seires) with 5 g Pt/m² is used for the anode in all cases, while the cathode is the CCM or GDE described herein. FIGS. 9A-9D depict an exemplary fuel cell electrode assembly containing platinum dots on 112 Nafion membrane with increasing magnification. FIGS. 10A-10C depict SEM micrographs in increasing magnification of an array of platinum dots supported on a gas diffusion layer (GDL) to form GDE, in contrast to the configuration of a CCM per FIGS. 9A-9D.

### Example 2

### Determining an Appropriate Array Size of the Catalyst Regions Per a Given Design

Commercially available metal meshes of different sizes are used as a mask to generate the array patterns and resultant surface areas are calculated. Table I is a worksheet showing various surface areas resulting from different mesh sizes.

TABLE I

| | mesh | | |
|---|---|---|---|
| Mesh Size | opening | Number of | Total Surface Area* |
| (wires/inch) | (μm) | Openings per 1 cm² | (cm²/cm²) |
| 1500 | 11 | 348k | 0.44 × 2** |
| 1000 | 18 | 154k | 0.5 × 2 |
| 750 | 25 | 87k | 0.55 × 2 |
| 500 | 39 | 38k | 0.60 × 2 |
| 300 | 66 | 14k | 0.61 × 2 |

*The total surface area as referenced in Table I refers to a total surface area calculated from both sides of the catalyst regions such as the catalyst regions 204 without the wires 602.
**The number “2” referenced in this column indicates both sides of the catalyst regions such as the catalyst regions 204 described herein are included in the calculation of the total surface area of Table I.

As can be seen from Table I, the total surface area generally increases with the size of mesh opening.

This example shows that surface area provided by the mesh itself may not be sufficient for fuel cell applications. In this connection, nanowires described herein elsewhere may be needed to provide requisite surface area for a given fuel cell application.

### Example 3

### Further Surface Area Determinations and Enhancements

In one variation of this example, wires having diameters of 150 nm and length of 1.3 μm are grown on arrays formed from various mesh sizes shown in Table I, with enhancement in surface area shown in Table II. In another variation of this example, wires having diameters of 13 nm and length of 1.0 μm are grown on arrays formed from various mesh sizes shown in Table II, with enhancement in surface area shown in Table III.

TABLE II

| | Total Area | Pt Loading* |
|---|---|---|
| Array Size | cm²/cm² | mg/cm² |
| 1500 | 12.7 | 0.04 |
| 1000 | 14.7 | 0.05 |
| 750 | 16.0 | 0.05 |
| 500 | 17.4 | 0.06 |
| 300 | 17.5 | 0.06 |

TABLE III

| | Total Area | Pt Loading* |
|---|---|---|
| Array Size | cm²/cm² | mg/cm² |
| 1500 | 18.2 | 0.06 |
| 1000 | 21.0 | 0.07 |
| 750 | 22.9 | 0.08 |
| 500 | 24.9 | 0.08 |
| 300 | 25.0 | 0.08 |

*The Pt loading in Table II and Table III is calculated based on four (4) atomic layers.

### Example 4

### Forming Wires on a Mesh Substrate

Several methods can be used to manufacture the wires as described herein. Among them are evaporation-condensation, vapor-liquid-solid (VLS) growth, and template based.

FIGS. 12A1-A2, B1-B2, C1-C2, 12D and 12E1-E2 collectively illustrate the steps taken to generate the wires 1110 on an interconnected mesh substrate. FIG. 12A1 depicts an enlarged sectional view of the interconnected network of FIG. 11A. FIG. 12A2 depicts an enlarged cross-sectional view of one of the spaced apart strands 1104 of FIG. 12A1 taken along line AA′. FIGS. 12B1-6B2 depict enlarged sectional view of the strand 1104 having thereupon an organic material 1202 as a base for forming the wires via annealing. FIGS. 12C1-12C2 depict enlarged sectional view of the strand 1104 having thereupon a plurality of pores 1204 generated via the heat-assisted annealing. FIGS. 12D, 12E1 and 12E2 collectively depict an enlarged sectional view of the strand 1104 having wires 1206 formed thereupon.

### Example 5

### Surface Area Values of the Resultant Substrates

The calculations shown in Table V indicate that a mesh substrate equipped with wires of 55 nanometers in diameter, 1.2 micrometers in length and a density of 5×10⁹/cm² can provide surface areas of about 13 to 17 cm²/cm². This surface area can easily be increased by increasing the length of the wires.

| Micron | Mesh Size | Total Surface |
|---|---|---|
| Rating | Strands per inch | Area cm2/cm2 |
| 11 | 1500 | 16.9 |
| 18 | 1000 | 15.9 |
| 25 | 750 | 14.6 |
| 39 | 500 | 13.4 |
| 66 | 300 | 13.0 |

While the best mode for carrying out the invention has been described in detail, those familiar with the art to which this invention relates will recognize various alternative designs and embodiments for practicing the invention as defined by the following claims.

What is claimed is:

1. A catalytic assembly comprising:
a porous substrate including at least one of a mesh structure and an array structure, wherein the mesh structure includes first spaced apart strands extending longitudinally in a first direction, and second spaced apart strands extending longitudinally in a second direction, the first and second spaced apart strands collectively defining openings bounded by an adjacent pair of the first spaced apart strands and an adjacent pair of the second spaced apart strands, wherein the array structure includes a number of spaced apart regions each having a surface and a thickness dimension extending from the surface, the surface including a linear dimension greater than the thickness dimension;
a number of wires including an organic material and contacting the substrate; and
a catalyst film contacting at least a portion of the number of wires.

2. The catalytic assembly of claim 1, wherein the catalyst film further contacts at least a portion of the substrate.

3. The catalytic assembly of claim 1, wherein at least a portion of the openings have a geometric shape selected from the group consisting of a rectangular, a square, an oval, a circle, and combinations thereof.

4. The catalytic assembly of claim 3, wherein at least two adjacent openings have a same geometric shape.

5. The catalytic assembly of claim 1, wherein at least a portion of the spaced apart regions have a geometric shape selected from the group consisting of a rectangular, a square, an oval, a circle, and combinations thereof.

6. The catalytic assembly of claim 1, wherein at least two adjacent regions have a same geometric shape.

7. The catalytic assembly of claim 1, wherein the number of wires extend radially from an exterior surface of the substrate.

8. The catalytic assembly of claim 1, wherein the catalyst film further contacts the first spaced apart strands and the second spaced apart strands.

9. The catalytic assembly of claim 1, wherein the catalyst film further contacts the spaced apart regions.

10. The catalytic assembly of claim 1, wherein the catalyst film has a film surface and a thickness, the film surface contacting the porous substrate, the thickness being of 2 to 20 atomic layers.

11. The catalytic assembly of claim 10, wherein the film surface of the catalyst film has a linear dimension of at least 30 nanometers.

12. The catalytic assembly of claim 11, wherein the catalyst film contacts the substrate continuously along at least 90 percent of the linear dimension of the film surface.

13. The catalytic assembly of claim 1, wherein the substrate has a thickness dimension of 5 to 25 micrometers.

14. The catalytic assembly of claim 1, wherein the substrate has a surface linear dimension of between 25 cm to 250 cm.

15. The catalytic assembly of claim 1, wherein the organic material is N,N′-di(3,5-xylyl)perylene-3,4,9,10 bis(dicarboximide).

16. The catalytic assembly of claim 1, wherein the number of wires each include an end and a length with an aspect ratio of the length to end being greater than 2, the end contacting the porous substrate.

17. The catalytic assembly of claim 1, further comprising a second porous substrate disposed next to the porous substrate already existing.

18. A method of forming a catalytic assembly including a porous substrate, the method comprising:
depositing an organic material onto a porous substrate to form a coating of the organic material, the porous substrate including at least one of a mesh structure and an array structure, wherein the mesh structure includes first spaced apart strands extending longitudinally in a first direction, and second spaced apart strands extending longitudinally in a second direction, the first and second spaced apart strands collectively defining openings bounded by an adjacent pair of the first spaced apart strands and an adjacent pair of the second spaced apart strands, wherein the array structure includes a number of spaced apart regions each having a surface and a thickness dimension extending from the surface, the surface including a linear dimension greater than the thickness dimension;
subjecting the coating of the organic material to an elevated temperature to form a number of wires of the organic material; and
contacting at least a portion of the number of wires with a catalyst.

19. The method of claim 18, wherein the number of wires are formed via heat-assisted annealing of the coating of the organic material.

20. A catalytic assembly comprising:
a porous substrate having a thickness of greater than 1 micrometer and including at least one of a mesh structure and an array structure, wherein the mesh structure includes first spaced apart strands extending longitudinally in a first direction, and second spaced apart strands extending longitudinally in a second direction, the first and second spaced apart strands collectively defining openings bounded by an adjacent pair of the first spaced apart strands and an adjacent pair of the second spaced apart strands, wherein the array structure includes a number of spaced apart regions each having a surface and a thickness dimension extending from the surface, the surface including a linear dimension greater than the thickness dimension;
a number of wires including an organic material and contacting the substrate, the organic material including N,N′-di(3,5-xylyl)perylene-3,4,9,10 bis(dicarboximide); and
a catalyst film contacting at least a portion of the number of wires.
